(19) United States
(12) Patent Application Publication
(10) Pub. No.: US 2007/0299200 A1
(43) Pub. Date: Dec. 27, 2007

(54) Hydrogenated Nitrile Rubber Composition

(76) Inventors: Osamu Kobayashi, Tokyo (JP); Takuya Yamanaka, Tokyo (JP)

Correspondence Address: BUTZEL LONG, 350 SOUTH MAIN STREET, SUITE 300, ANN ARBOR, MI, 48104, US

(21) Appl. No.: 11/667,170

(22) PCT Filed: Nov. 2, 2005
(86) PCT No.: PCT/JP05/20206

§ 371 Date: May 4, 2007

(30) Foreign Application Priority Data
Apr. 11, 2004 (JP) 2004-320319

(51) Int. Cl. C08L 15/00; C08K 3/04; C08K 5/103; F16J 15/10; C09K 3/10; C08K 7/06

(52) U.S. Cl. 524/555

(57) ABSTRACT

A hydrogenated nitrile rubber composition, which comprises 100 parts by weight of hydrogenated nitrile rubber having a Mooney viscosity ML₁₊₄ (100° C.) of 100 or less, an acrylonitrile content of 30-50%, and an iodine value of 28 or less, 60-250 parts by weight of carbon fibers, and 12-70 parts by weight of a polyfunctional group-based cocross-linking agent having a molecular weight of 150-500, and a viscosity (20° C.) of 3-120 mPa·s. The composition can further contain 30-150 parts by weight of carbon black and/or 60 parts by weight or less of graphite. The resulting hydrogenated nitrile rubber composition enables higher loadings of carbon fibers without lowering the kneadability and the molding processability, thereby improving the abrasion resistance of seal materials cross-linking molded from the composition.

### TECHNICAL FIELD

The present invention relates to a hydrogenated nitrile rubber composition, and more particularly to a hydrogenated nitrile rubber composition for suitable use as a molding material for seal materials having a distinguished abrasion resistance.

### BACKGROUND ART

As a result of the recent increasing requirements for higher performance of various industrial machines and devices, use circumstances of seal materials provided at the sliding parts of machines and devices have been under severe conditions such as higher temperatures, higher pressure, and higher speeds, so that a long durability such as higher heat resistance and higher pressure resistance, and a longer life has been required for the seal materials, and thus an improvement in the abrasion resistance is indispensable for maintaining to show a long-term seal performance.

To solve such problems, molding materials containing various fillers such as carbon black, silica, carbon fibers, etc. in a higher loadings into a rubber or resin composition have been so far proposed. However, the abrasion resistance has not been fully obtained in many cases, depending on the use conditions of seal materials. Fillers, when contained in a higher loadings, will deteriorate the kneadability. When a large amount of a plasticizer is added thereto to prevent the deterioration, physical properties will be considerably lowered, in the case of plasticizer is extracted into oil, grease, water, etc.

Patent Literature 1: JP-A-6-220286

Patent Literature 2: JP-A-11-80481

Patent Literature 3: JP-A-2002-80639

Patent Literature 4: JP-A-2002-146342

Patent Literature 5: JP-A-2002-194156

Patent Literature 6: JP-A-2002-212361

As to hydrogenated nitrile rubber compositions of higher loadings with carbon fibers, one of the present inventors has so far proposed a hydrogenated nitrile rubber composition, which comprises 100 parts by weight of hydrogenated nitrile rubber having an acrylonitrile content of 30% or more, a polymer Mooney viscosity ML₁₊₄ (100° C.) of 80 or less (center value) (according to JIS K6395) and an iodine value of 28 or less (center value) and 65-200 parts by weight of carbon fibers, as a suitable one for a molding material etc. of sealing materials, capable of overcoming problems as to the kneadability or the moldability, and also improving the abrasion resistance, and has recommended using a polyfunctional unsaturated compound such as triallyl(iso)cyanurate, trimethylolpropane tri(meth)acrylate, triallyl trimellitate, butadiene oligomer, etc. in a proportion of about 1 to about 10 parts by weight, preferably about 2 to about 8 parts by weight, to 100 parts by weight of hydrogenated nitrile rubber, together with a organic peroxide cross-linking agent at the same time.

Patent Literature 7: JP-A-2004-217851

The proposed hydrogenated nitrile rubber composition has solved the problem as desired, though actually there remains still a further improvement in the abrasion resistance.

### DISCLOSURE OF THE INVENTION

### Problem to be Solved by the Invention

An object of the present invention is to provide a hydrogenated nitrile rubber composition capable of attaining higher loadings of carbon fibers without lowering the kneadability and molding processability, thereby improving the abrasion resistance of cross-linking molded seal materials.

### Means for Solving the Problem

The object of the present invention can be attained by a hydrogenated nitrile rubber composition, which comprises 100 parts by weight of hydrogenated nitrile rubber having a Mooney viscosity ML₁₊₄ (100° C.) of 100 or less, an acrylonitrile content of 30-50%, and an iodine value of 28 or less, 60-250 parts by weight of carbon fibers, and 12-70 parts by weight of a polyfunctional group-based cocross-linking agent having a molecular weight of 150-500, and a viscosity (20° C.) of 3-120 mPa·s.

### EFFECT OF THE INVENTION

The present hydrogenated nitrile rubber composition can attain higher loadings of carbon fibers without lowering the kneadability and the molding processability by adding a polyfunctional group-based cocross-linking agent having a low viscosity, and can also thereby improve the abrasion resistance of cross-linking molded seal materials. Furthermore, addition of a large amount of the polyfunctional group-based cocross-linking agent can remarkably improve the normal state physical properties, particularly 10% modulus value, an extraction resistance to various fluids in contact with the seal materials, and an abrasion resistance which controls a sealability.

More specifically, seal materials having a high abrasion resistance suitable for sealing a fluid, while sliding along a hard material such as metals, etc. in a relative motion under severe conditions such as higher temperature, higher pressure, higher speed, etc. can be obtained by cross-linking molding the present hydrogenated nitrile rubber composition, where fluids in contact with the seal materials include, for example, oils such as engine oil, gear oil, transmission oil, etc.; water or liquids such as aqueous solutions containing water as the main component, for example, a long-life coolant; refrigerant gases such as flon, etc.; and gases such as natural gas, nitrogen, oxygen, etc.

### BRIEF DESCRIPTION OF DRAWINGS

FIG. 1 a schematic view showing a lip seal mounting position of an abrasion-evaluating tester.

FIG. 2 a cross-sectional view of oil seal for abrasion-evaluating of lip seal.

FIG. 3 a schematic view showing an abrasion depth measurement part at the tip end of a lip seal.

### DESCRIPTION OF REFERENCE NUMERALS

1 Test piece for abrasion-evaluating test (lip seal)
2 Rotary shaft
3 Sliding part
4 Housing
5 Rubber lip
6 Spring
7 Metallic ring

### BEST MODES FOR CARRYING OUT THE INVENTION

Hydrogenated nitrile rubber for use in the present invention has a Mooney viscosity ML₁₊₄ (100° C.) of 100 or less, preferably 50-85 (according to JIS K6395), an acrylonitrile (AN) content of 30-50%, an iodine value of 0-28 g/100 g. When the Mooney viscosity is over 100, kneading of a large amount of carbon fibers will be hard to conduct, resulting in molding failure, and even if kneaded, flow failure will occur at the time of molding, resulting in failure in molding of products in a desired shape. Various AN contents can be selected, depending on the desired sealing, but an AN content of less than 30% will considerably increase a gas permeability, resulting in failure in functioning as a gas shielding material. An iodine value of more than 28 will deteriorate the heat resistance.

Carbon fibers for use in the present invention include, for example, PAN-based carbon fibers, pitch-based carbon fibers, rayon-based carbon fibers, etc., which generally are about 1 to about 20 μm, preferably about 5 to about 15 μm in fiber diameter, and about 0.03 to about 1 mm, preferably about 50 to about 500 μm in fiber length. The carbon fibers having such properties can be used in a proportion of about 60 to about 250 parts by weight, preferably about 60 to about 200 parts by weight, to 100 parts by weight of hydrogenated nitrile rubber. In a proportion of less than about 60 parts by weight, no satisfactory abrasion resistance will be obtained, whereas in a proportion of more than about 250 parts by weight the kneadability or molding processability will be deteriorated at the time of adding other carbon-based filler and the resulting seal materials will have no practical use at the time of adding other carbon-based filler.

Fillers other than carbon fibers include, for example, carbon black, graphite, etc. and can be used together with carbon fibers. Any carbon black of e.g. SRF, GPF, FEF, HAF, IISAF, ISAF, SAF, etc., so long as can improve the abrasion resistance, can be used in a proportion of about 30- about 150 parts by weight to 100 parts by weight of hydrogenated nitrile rubber. Graphite can be used in a proportion of 0-60 parts by weight, preferably about 10 to about 60 parts by weight, to 100 parts by weight of hydrogenated nitrile rubber. The abrasion resistance can be further improved by simultaneous use of graphite, but sum total proportion of fillers including carbon fibers is set to about 90 to about 350 parts by weight, preferably about 120 to about 300 parts by weight, to 100 parts by weight of hydrogenated nitrile rubber. In a proportion of less than about 90 parts by weight of the fillers, no satisfactory abrasion resistance will be obtained, whereas in a proportion of more than 350 parts by weight the kneadability and molding processability will be deteriorated.

To provide a seal material having an abrasion resistance suitable for sealing a fluid under severe conditions such as higher temperature, higher pressure, and higher speed, it is necessary that the normal state physical properties will not be lowered at elevated temperatures due to heat generation by sliding. From this point of view, it is selected to use hydrogenated nitrile rubber, and add carbon fibers and other fillers thereto to improve the abrasion resistance. Furthermore, it is added a liquid polyfunctional group-based cocross-linking agent thereto to overcome the deterioration of kneadability due to higher loadings of carbon fibers, and also to enable the carbon fiber fillers in a higher loadings. That is, a liquid polyfunctional group-based cocross-linking agent is a liquid having a low viscosity at the time of kneading and molding processing, which can lower the viscosity of the composition, and can attain higher loadings of the fillers without deteriorating the kneadability, and also can be cross-linked at the time of rubber cross-linking, thereby improving the reinforcing effect and the extraction resistance to various fluids in contact with the seal materials at the same time.

Polyfunctional group-based cocross-linking agent for use in the present invention includes, for example, a bifunctional group-based cross-linking agent such as ethylene glycol di(meth)acrylate, triethylene glycol di(meth)acrylate, 1,3-butylene glycol di(meth)acrylate, 1,6-hexanediol di(meth)acrylate, etc., and a trifunctional group-based cocross-linking agent such as trimethylolpropane tri(meth)acrylate, triallyl (iso)cyanurate, etc. which can be used alone or in mixture thereof. The term “(meth)acrylate” means either acrylate or methacrylate, and the term “(iso)cyanurate” likewise means either cyanurate or isocyanurate. Among these polyfunctional group-based cocross-linking agents, those which have a molecular weight of about 150 to about 500, and a viscosity (20° C.; as measured by B type viscosimeter) of about 3 to about 120 mPa·s, showing a liquid state at the ordinary temperature, can be used in a proportion of 12-70 parts by weight, preferably 12-50 parts by weight, to 100 parts by weight of hydrogenated nitrile rubber. In a proportion of less than 12 parts by weight, neither improvements of kneadability or molding processability in case of using higher loadings of carbon fibers or reinforcing effect in case of using carbon fibers of higher loadings, nor improvements of extraction resistance to various fluids can be attained, whereas in a proportion of more than 70 parts by weight wrapping around rolls will be lowered due to bleed generation, resulting in deterioration of the kneadability.

A liquid oligomer such as liquid polybutadiene oligomer, etc. can be used as a polyfunctional group-based cocross-linking agent in a proportion of not more than 10 parts by weight, preferably 3-6 parts by weight, to 100 parts by weight of hydrogenated nitrile rubber. The liquid polybutadiene oligomer has a high viscosity, for example, about 15,000 to about 35,000 mPa·s (20° C.) in the case of JSR product B 3000 as used in the following Examples and Comparative Examples, and thus it fails to act as an afore-mentioned low viscosity polyfunctional group-based cocross-linking agent, enabling higher loadings of fillers without lowering the kneadability and the moldability, though it can act as a cocross-linking agent.

The present hydrogenated nitrile rubber composition comprising the afore-mentioned essential components can be generally peroxide cross-linked with an organic peroxide. Organic peroxide for use in the present invention includes, for example, di-t-butyl peroxide, dicumyl peroxide, t-butylcumyl peroxide, 1,1-di(t-butylperoxy)-3,3,5-trimethylsiloxane, 2,5-dimethyl-2,5-di(t-butylperoxy)hexane, 2,5-dimethyl-2,5-di(t-butylperoxy)hexine-3, 1,3-di(benzoylperoxy)hexane, t-butylperoxybenzoate, t-butylperoxy isopropyl carbonate, n-butyl-4,4′-di(t-butylperoxy)valerate, etc., and can be used in a proportion of about 1 to about 10 parts by weight, preferably about 2 to about 8 parts by weight, to 100 parts by weight of hydrogenated nitrile rubber.

The present composition can be further admixed, if necessary, with a processing aid, an acid acceptor such as divalent metal oxide or hydroxide, hydrotalcite, etc., an antioxidant, a plasticizer, etc., besides the afore-mentioned components, and kneaded by the ordinary kneading method using a kneader, a Banbury mixer, rolls, etc., and the kneaded composition can be cross-linking molded into desired shapes by primary cross-linking at about 160° to about 220° C. for about 3 to about 10 minutes using a compression molding machine, an injection molding machine, etc., and if necessary, by secondary cross-linking at about 150° to 200° C. for about 1 to about 30 hours. In the case of molding as a seal material, the resulting seal material shows a good abrasion resistance, even if used as a seal material in sliding contact with a rotating shaft under the afore-mentioned severe conditions for a long time, and thus can fully show a desired sealing performance.

### EXAMPLES

The present invention will be described in detail below, referring to Examples.

### Example 1

| | Parts by weight |
|---|---|
| Hydrogenated NBR (Nippon Zeon product, Zetpol 2000; | 100 |
| AN content: 36.2%; Mooney viscosity ML₁₊₄(100° C.): | |
| 85; iodine value: 7 or less) | |
| SRF carbon black | 100 |
| Carbon fibers (Osaka Gas Chemical product, pitch- | 150 |
| based carbon fibers; fiber diameter: 10 μm; fiber | |
| length: 0.06 mm) | |
| Graphite (Nichiden Carbon product, AO) | 20 |
| Antioxidant (Uniroyal product, #445) | 3 |
| Organic peroxide (NOF Corp. product, percumyl D) | 5 |
| Trimethylolpropane trimethacrylate | 30 |
| (trifunctional group-based cocross-linking agent) | |
| (Mitsubishi Rayon product, Acryester TMP; molecular | |
| weight: 338.41; viscosity (20° C.): 57.0 mPa · s) | |
| Liquid butadiene oligomer (JSR product, B 3000) | 5 |

The foregoing components were kneaded through a 3 L kneader and 10-inch rolls, and then vulcanization molded into sheets, 2 mm in thickness, using a compression molding machine under conditions of 180° C. for 6 minutes. The sheets were then subjected to measurement or evaluation of the following test items.

Kneadability: evaluated by state of bagging occurrence at the time of kneading through 10-inch rolls, where bagging non-occurrence was evaluated as “◯”, bleed generation by “Δ”, and bagging occurrence as “x”

Moldability: evaluated by flowability at the time of molding of 2 mm-thickness sheets, where good flowability was evaluated as “◯”, and poor flowability (failure to mold) as “x”

Normal state physical properties: owing to small elongation at break, 10% modulus was measured according to JIS K6251 (corresponding to ISO 37)

Lubricating oil resistance: dipped into lubricating oil to measure percent weight of extract according to JIS K6258 (corresponding to ISO 1817)

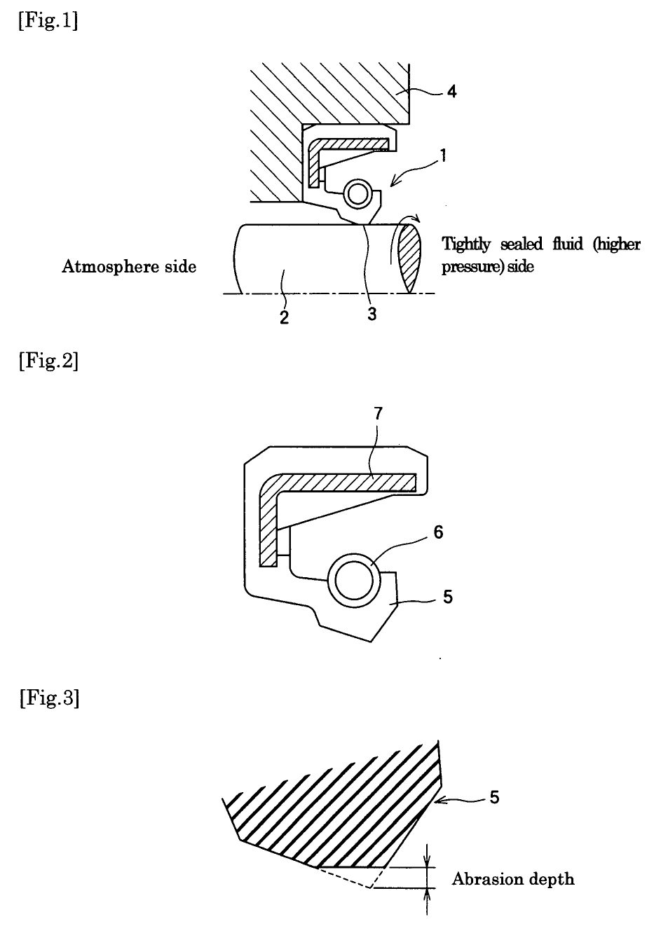

Abrasion evaluation: shaft lip seals (inner diameter: 12 mm) were subjected to a shaft revolution test, using two kinds of fluids to be sealed, i.e. engine oil (turbine oil VG 32) and water (ion-exchanged water), under conditions of peripheral speed: 5 m/sec. fluid pressure: 5 MPa, fluid temperature: 150° C. and testing time: 10 hours to measure lip part abrasion depth and leaked fluid weight (sealability) (see FIGS. 1 to 3)

### Example 2

In Example 1, the amount of trimethylolpropane trimethacrylate was changed to 15 parts by weight, and 15 parts by weight of triethylene glycol dimethacrylate (Mitsubishi Rayon product, Acryester 3ED; molecular weight: 286.33; viscosity (20° C.): 10.2 mPa·s) was additionally used as a bifunctional group-based cocross-linking agent.

### Example 3

In Example 1, the same amount of triethylene glycol dimethacrylate (Acryester 3ED) was used in place of trimethylolpropane trimethacrylate.

### Comparative Example 1

In Example 1, no trimethylolpropane trimethacrylate was used.

### Comparative Example 2

In Example 1, the amount of trimethylolpropane trimethacrylate was changed to 8 parts by weight.

### Comparative Example 3

In Example 1, the amount of carbon fibers was changed to 45 parts by weight.

### Comparative Example 4

In Example 1, the same amount of dioctyl phthalate was used in place of trimethylolpropane trimethacrylate.

Results of measurement or evaluation in the foregoing Examples and Comparative Examples are shown in the following Table. In Comparative Example 1, the sign “-” shows that the evaluation was not made due to molding failure. It can be concluded from the results give in Table that:

(1) Addition of a large amount of polyfunctional group-based cocross-linking agent enables higher loadings of carbon fibers without deteriorating the kneadability and the molding processability,

(2) Increase in the amount of added carbon fibers enables the abrasion resistance of seal materials, and

(3) Addition of polyfunctional group-based cocross-linking agent can improve 10% modulus and the lubricating oil resistance, the abrasion resistance remarkably.

TABLE

| Example No. | | | Comp. Ex. No. | | | |
|---|---|---|---|---|---|---|
| 1 | 2 | 3 | 1 | 2 | 3 | 4 |

Measurement · Evaluation item

| | | | | | | | | |
|---|---|---|---|---|---|---|---|---|
| Kneadability | | ◯ | ◯ | ◯ | X | Δ | ◯ | Δ |
| Moldability | | ◯ | ◯ | ◯ | X | ◯ | ◯ | ◯ |
| 10% modulus | (MPa) | 30 | 20 | 13 | — | 12 | 13 | 9 |

Lubricating oil

| | | | | | | | | |
|---|---|---|---|---|---|---|---|---|
| resistance | (%) | 0.5 | 0.7 | 1.1 | — | 0.6 | 1.0 | 7 |

Abrasion evaluation
Abrasion depth

| | | | | | | | | |
|---|---|---|---|---|---|---|---|---|
| Engine oil | (mm) | 0.02 | 0.05 | 0.09 | — | 0.18 | 0.40 | 0.29 |
| Water | (mm) | 0.05 | 0.10 | 0.19 | — | 0.30 | 0.62 | 0.40 |

Amount of leaked fluid

| | | | | | | | | |
|---|---|---|---|---|---|---|---|---|
| Engine oil | (g) | 0.010 | 0.008 | 0.011 | — | 0.080 | 0.18 | 0.14 |
| Water | (g) | 0.015 | 0.010 | 0.019 | — | 0.011 | 0.20 | 0.16 |

1: A hydrogenated nitrile rubber composition, which comprises 100 parts by weight of hydrogenated nitrile rubber having a Mooney viscosity ML₁₊₄ (100° C.) of 100 or less, an acrylonitrile content of 30-50%, and an iodine value of 28 or less, 60-250 parts by weight of carbon fibers, and 12-70 parts by weight of a polyfunctional group-based cocross-linking agent having a molecular weight of 150-500, and a viscosity (20° C.) of 3-120 mPa·s.

2: A hydrogenated nitrile rubber composition according to claim 1, wherein the hydrogenated nitrile rubber has a Mooney viscosity ML₁₊₄-(100° C.) of 50-80.

3: A hydrogenated nitrile rubber composition according to claim 1, further comprising 30-150 parts by weight of carbon black.

4: A hydrogenated nitrile rubber composition according to claim 3, wherein a sum total of fillers contained in the composition, including the carbon fibers and carbon black is 90-350 parts by weight.

5: A hydrogenated nitrile rubber composition according to claim 1, further comprising 60 parts by weight or less of graphite.

6: A hydrogenated nitrile rubber composition according to claim 5, wherein a sum total of fillers contained in the composition, including the carbon fibers and graphite is 90-350 parts by weight.

7: A hydrogenated nitrile rubber composition according to claim 3, further comprising 60 parts by weight or less of graphite.

8. A hydrogenated nitrile rubber composition according to claim 7, wherein a sum total of fillers contained in the composition, including the carbon fibers, carbon black and graphite is 90-350 parts by weight.

9: A molding material for seal materials which comprises the hydrogenated nitrile rubber composition according to claim 1.

10: A molding material for seal materials which comprises the hydrogenated nitrile rubber composition according to claim 3.

11. A molding material for seal materials which comprises the hydrogenated nitrile rubber composition according to claim 5.

12: A molding material for seal materials which comprises the hydrogenated nitrile rubber composition according to claim 7.

13: A seal material cross-linking molded from a hydrogenated nitrile rubber composition according to claim 9.

14: A seal material cross-linking molded from a hydrogenated nitrile rubber composition according to claim 10.

15: A seal material cross-linking molded from a hydrogenated nitrile rubber composition according to claim 11.

16: A seal material cross-linking molded from a hydrogenated nitrile rubber composition according to claim 12.

17: A seal providing fluid sealing while sliding along a metal surface in relative motion which comprises the seal material according to claim 13.

18: A seal providing fluid sealing while sliding along a metal surface in relative motion which comprises the seal material according to claim 14.

19: A seal providing fluid sealing while sliding along a metal surface in relative motion which comprises the seal material according to claim 15.

20: A seal providing fluid sealing while sliding along a metal surface in relative motion which comprises the seal material according to claim 16.
